(19) United States
(12) Patent Application Publication
(10) Pub. No.: US 2026/0255072 A1
(43) Pub. Date: Aug. 27, 2026

(54) COLOUR AND MONOCHROME CAMERA

(71) Applicant: PIXII SAS, Besançon (FR)

(72) Inventor: David Barth, Besançon (FR)

(73) Assignee: PIXII SAS, Besançon (FR)

(21) Appl. No.: 18/875,808

(22) PCT Filed: Jun. 19, 2023
(86) PCT No.: PCT/EP2023/066493

§ 371 Date: Dec. 17, 2024

(30) Foreign Application Priority Data
Jun. 20, 2022 (FR) 2206012

(51) Int. Cl. H04N 23/84; H04N 23/62; H04N 23/667

(52) U.S. Cl. CPC H04N 23/843; H04N 23/62; H04N 23/667

(57) ABSTRACT

The method for generating a digital data file representative of information received by an image sensor of an optical device of a colour camera includes: -a user selecting a monochrome mode via a human-machine interface; -the image sensor, having a multitude of photosites, receiving a light intensity through an optical device having a colour filter intended to form a colour image; -estimating a calculation of a monochrome light intensity received by all or some of the photosites or groups of photosites of the image sensor, such as would be received without the presence of the colour filter; and -storing a digital file representative of the monochrome image perceived by the image sensor, including, for all or some of the photosites or group of photosites of the image sensor, digital data representative of the received monochrome light intensity, without a colour filter, resulting from the estimated calculation.

### TECHNICAL FIELD OF THE INVENTION

The invention relates to a method for generating a digital data file representative of information received by an image sensor of a color camera. It also relates to a camera as such.

### BACKGROUND ART

In the photography field, black and white images are appreciated as a distinct artistic form. To produce images in black and white, also known as monochrome images, only rare so-called monochrome cameras, that is to say those equipped with an image sensor with no color filter, are able to produce a raw digital file representative of a monochrome image. Monochrome digital cameras are therefore cameras in which the image sensor has no color filter. On the other hand, the image sensor of a color digital camera is associated with an optical device including a color filter so that the photo sites of the image sensor receive only some of the received photons, filtered to preserve only a predefined color.

A color camera can be converted to a monochrome camera by physically removing the color filter of the optical device associated with this image sensor. This is a delicate and potentially destructive operation that can be carried out only using dedicated installations, notably to prevent pollution by dust of the space between the sensitive zone of the sensor and the glass protecting it. No color camera is designed for such transformation.

In practise, a photographer is therefore equipped with two distinct cameras, a color camera and a monochrome camera. This situation is obviously not ideal.

An alternative solution for a photographer is to work on a color image a posteriori, using software that proposes transformation of a color image into black and white, or shades of grey, which corresponds to a monochrome image. These image treatments operate on a digital file that can be viewed, that is to say a standardized digital file directly usable by software to display an image on a screen. The format of a digital file that can be viewed is transformed relative to a raw digital file, commonly referred to as RAW digital file, or a file in the native format in the field of photography. This transformation leads to a loss of information relative to the raw digital file directly obtained from the image sensor of a camera. For example, images to the standardized JPEG format are based on an 8-bit dimension as opposed to a raw (RAW) format that comprises data to a much larger scale. Because of this, any treatment of an image on the basis of such a transformed digital file, also referred to here as a viewable digital file, even if it is able to generate a monochrome image, is necessarily limited relative to the final quality of the image that it is able to produce since it cannot take account of the lost data. This results in a monochrome image of less than optimum quality.

### SUMMARY OF THE INVENTION

The aim of the invention is to provide a solution enabling a photographer to obtain color and monochrome images of high quality in a user-friendly manner.

To this end, the invention is based on a method for generating a digital data file representative of information received by an image sensor of an optical device of a color camera, comprising the following steps:
a user selecting a monochrome mode via a human-machine interface;
the image sensor, comprising a multitude of photosites, receiving luminous intensity through an optical device comprising a color filter intended to form a color image;
calculating an estimate of a monochrome luminous intensity received by all or some of the photosites or groups of photosites of the image sensor, such as would be received without the presence of the color filter of the optical device; and
storing a digital file representative of the monochrome image perceived by the image sensor, comprising, for all or some of the photosites or groups of photosites of the image sensor, a digital datum representative of said received monochrome luminous intensity, without a color filter, resulting from said calculation of the estimate.

The step of calculating an estimate of a monochrome luminous intensity received by a given photosite may take into account the luminous intensity received by a plurality of adjacent photosites of the image sensor.

The step of calculating an estimate of a monochrome luminous intensity received by said given photosite may consider said monochrome luminous intensity to be equal to the maximum luminous intensity received from said plurality of adjacent photosites or calculate said monochrome luminous intensity by means of a weighted sum as a function of the color of the luminous intensity received by said plurality of adjacent photosites.

The step of calculating an estimate may comprise the following substeps:
transferring to a preprocessing unit an electrical signal representative of the quantity of photons received by at least one photosite of the image sensor; and
following reception of electrical signals representative of the quantity of photons received by said at least one photosite and a few adjacent photosites of the image sensor, calculating an estimate of the monochrome luminous intensity received by said at least one photosite on the fly; and
storing in said digital file a digital datum representative of said monochrome luminous intensity received by said at least one photosite; or
calculating an estimate of a monochrome luminous intensity received by some or all of the photosites or groups of photosites of the image sensor after receiving electrical signals representative of the quantity of photons received by each photosite of the image sensor.

The digital file representative of the monochrome image perceived by the image sensor may be a RAW type raw digital file.

Said digital file representative of the monochrome image perceived by the image sensor further may comprise some or all of the following information:
a digital datum relating to the modification of the response curve of the pixels (tone curve);
a digital datum relating to a modification of the response of the pixels according to the frequency of the light captured by the latter;
a digital datum relating to a modification of the response of the pixels according to the spatial organization of the image captured by the image sensor.

The invention also relates to a method of generating a monochrome photograph that may comprise execution of the generation of a raw digital data file representative of the information received by an image sensor of a color camera as described above and may comprise a step of transmitting said digital data from said digital data file to a processing unit that transforms said raw digital file into another format that is viewable.

The invention also relates to a camera comprising an optical device comprising a color filter and an image sensor in order to generate a color photograph, characterized in that it comprises a human-machine interface enabling a user to choose a color or monochrome operating mode of said camera and in that it comprises a software module configured to execute a method for generating a digital data file representative of the information received by the image sensor, either of color type or of monochrome type, depending on the color or monochrome operating mode chosen by the user.

Said human-machine interface may comprise a two-position actuator, such as a pushbutton or a slider, these two positions respectively corresponding to the color and monochrome operating modes and may optionally comprise an indicator of the operating mode selected.

Said software module may be configured to use a method as described above for generating a digital data file and the camera may comprise a pre-processing unit intended to convert electrical signals coming from the photosites of the image sensor into digital data representative of a monochrome luminous intensity to form a raw digital file and a separate image signal processor ISP for transforming the raw digital file into a viewable digital file.

### BRIEF DESCRIPTION OF THE DRAWINGS

The above objects, features and advantages of the present invention are described in detail in the following description of one particular embodiment given by way of non-limiting example with reference to the appended figures in which:

FIG. 1 schematically represents the architecture of a camera in accordance with one embodiment of the invention.

FIG. 2 represents a first human-machine interface in accordance with one embodiment of the invention.

FIG. 3 represents a second human-machine interface in accordance with a variant of that embodiment of the invention.

### DETAILED DESCRIPTION OF PARTICULAR EMBODIMENTS

The present invention enables conversion of a color camera into a monochrome camera without having to remove the color filter from its sensor and maintaining the ability of the camera to produce raw images, that is to say a raw (RAW) digital file in the monochrome format. The present invention is reversible and also enables a monochrome camera transformed in this way to be converted back into a color camera.

The interest of a monochrome camera is to be able to produce rich raw (RAW) images the nature of which allows creative editing by the photographer during the development/post-processing phase; the present invention produces raw (RAW) images comparable to what an equivalent monochrome camera could produce.

The monochrome raw (RAW) images produced by the present invention can also enable production of black and white images ready to be viewed after their transformation into a viewable digital file, such as in the 8-bit JPEG format or some other format, by processing the monochrome raw images using the same methods of processing as a monochrome raw image produced by a monochrome sensor with no color filter.

To be more precise, the invention employs a method of generating a digital data file representative of information received by an image sensor of a color camera, comprising the following steps:
a user selecting a monochrome mode via a human-machine interface;
said image sensor, comprising a multitude of photosites, receiving luminous intensity through an optical device comprising a color filter intended to form a color image;
calculating an estimate of a monochrome luminous intensity received by all or some of the photosites or groups of photosites of the image sensor, such as would be received without the presence of the color filter of the optical device; and
storing a digital file representative of the monochrome image perceived by the image sensor, comprising, for all or some of the photosites of the image sensor, a digital datum representative of said received monochrome luminous intensity, without a color filter, resulting from the calculation of the estimate.

The step of calculating an estimate of a monochrome luminous intensity received by a given photosite enables generation of information directly at the level of the image sensor, upstream of any processing, compatible with the construction of a raw (RAW) digital file. Such a file comprises, for each photosite, a digital datum representative of the monochrome luminous intensity received by said photosite, this digital datum being in the native format of the sensor the size of which is at least 12 bits, notably 12 bits, or 14 bits, or 16 bits.

Because of the presence of a color filter in the optical device, each photosite of the image sensor receives only some of the incident photons, filtered in accordance with a frequency range corresponding to a particular color, generally red, green or blue, in the RGB color space. The concept of the invention consists in estimating the luminous intensity that each photosite would perceive in the absence of the color filter, referred to here as the monochrome luminous intensity.

This calculation of an estimate takes account of the luminous intensity received by a plurality of adjacent photosites. To this end, it is possible to consider a rectangle of N×M photosites centered on the photosite concerned. In this group of adjacent photosites, some perceive a red luminous intensity, others a green luminous intensity, others a blue luminous intensity.

A first approach is for the monochrome luminous intensity of the photosite concerned to be estimated to correspond to the maximum intensity received by the adjacent photosites concerned, generally a photosite receiving luminous intensity in the color green.

A second approach is for the monochrome luminous intensity of the photosite concerned to be estimated by the weighted addition of filtered intensities received for different colors by the adjacent photosites of different color. It is therefore possible to reconstruct the monochrome luminous intensity by adding the luminous intensities of the various colors that should have been received. Additionally, a multiplication factor may be used to compensate the loss of light introduced by the color filter, in addition to its color filtering.

To be more precise, this processing is carried out by the following substeps:
transferring to a preprocessing unit an electrical signal representative of the quantity of photons received by at least one photosite of the image sensor; and
following reception of electrical signals representative of the quantity of photons received by said at least one photosite and a few photosites of the image sensor adjacent to it, calculating an estimate of the monochrome luminous intensity received by said at least one photosite using either of the above approaches. Such a calculation is therefore effected on the fly, gradually as the electrical signals from the image sensor are received; and
storing in said digital file a digital datum representative of said monochrome luminous intensity received by said at least one photosite.

Alternatively, this calculation of an estimate need not be done on the fly. In this variant, the preprocessing unit receives electrical signals from each photosite of the image sensor before proceeding to calculate the monochrome luminous intensities of each photosite.

A third approach is for the monochrome luminous intensity of the photosite concerned to be estimated by a data processing structure based on neural networks, more generally by any artificial intelligence processing module. To this end, the module is first subjected to a training phase, comprising the processing of a large number of color images and corresponding monochrome images, such as those obtained from a traditional monochrome camera, that is to say with no color filter. In other words, a database is established comprising the same images obtained on the one hand by a color camera fitted with a color filter and on the other hand by a monochrome camera with no color filter. The neural network undergoes a learning phase in which it analyses all of these pairs of color and monochrome images and/or to be more precise in which it proceeds to read all of the data in the raw (RAW) files associated with those images. On this basis it is then able to generate automatically a monochrome RAW type file from a color RAW type file. Using such an approach, the processing module in fact uses all or virtually all of the data from each color RAW file without being limited to the adjacent photosites.

Thus the invention also relates to a method for generating a digital data file representative of information received by an image sensor of an optical device of a color camera, characterized in that it comprises the following steps:
a user selecting a monochrome mode via a human-machine interface;
said image sensor, comprising a multitude of photosites, receiving luminous intensity through an optical device comprising a color filter intended to form a color image;
calculating an estimate of a monochrome luminous intensity received by all or some of the photosites or groups of photosites of the image sensor, such as would be received without the presence of the color filter of the optical device;
storing a digital file representative of the monochrome image perceived by the image sensor, comprising, for all or some of the photosites or groups of photosites of the image sensor, a digital datum representative of said received monochrome luminous intensity, without a color filter, resulting from the calculation of the estimate,
   in which the calculation of an estimate is based on an artificial intelligence processing module, notably comprising a neural network having undergone beforehand a training process on the basis of RAW type files obtained from a color camera fitted with a color filter and a monochrome camera with no color filter.

Finally, because of the approach of the invention, the digital file generated is a good representation of the monochrome image perceived by the image sensor. It further comprises all the information that would have been received by an image sensor with no color filter, which enables construction of a RAW type raw digital file.

This raw digital file may further comprise other information useful for future processing of the monochrome image. For example, a digital datum relating to the modification of the response curve of the pixels (tone curve) by a device for modification of the response curve of the pixels (tone curve) stored in the raw (RAW) image file to be applied by external devices for production of an image ready to be viewed, said device enabling reproduction of the creative possibilities of analog photography linked to the rendition difference between different types of black and white film. It can also contain a digital datum relating to a modification of the response of the pixels according to the frequency of the light captured by them by a device for modification of the response of the pixels according to the frequency of the light captured by the latter, stored in the raw (RAW) file, such a device enabling, by way of non-exhaustive example, reproduction of the creative methods of using a monochrome camera the lens of which is equipped with a removable color filter (for example an orange filter) to highlight the vegetation or the sky in a photograph or to use the response of the image sensor beyond the range of visible colors (for example near infrared photography). The file may also contain a digital datum relating to modification of the response of the pixels according to the spatial organization of the image captured by the image sensor by a device for modification of the response of the pixels according to the spatial organization of the image captured by the image sensor, such a device enabling, by way of non-exhaustive example, modification of the resolution of the details of the captured image or transformation of the digital noise of the pixels into a different form of image grain comparable to the grain of a negative film.

The monochrome digital data file can thereafter naturally be processed in the classic manner, notably converted into a viewable digital file, for example to the JPEG standard. Thus the invention employs a method of generating a monochrome image characterized in that it comprises the use of the generation of a raw digital data file representative of the information received by an image sensor of a monochrome camera, as described above, and comprising transformation by a processing unit into another format that is directly viewable.

The above method enables generation of a digital datum for each photosite of the image sensor, that is to say reconstruction of the monochrome information for each photosite of the image sensor. Such an approach is ideal because it provides the maximum information and enables the construction of an image with a maximum number of pixels. Nevertheless, to simplify the calculation and/or to reduce the amount of information to be stored, the method could instead be applied to groups of photosites, calculating the monochrome luminous intensity received by a group of photosites and not each individual photosite. Such an approach amounts to considering an image sensor with fewer photosites for a final image with fewer pixels.

The method described above naturally comprises in parallel the classic color option. Thus the user is able to select the color mode, in which case operation remains that of a classic color camera, with the aim of generating a color image.

The method may further comprise the complementary steps of acquisition of data comprising all or some of:
i. the value of all of the pixels of the sensor,
ii. metadata representing the parameters of the image sensor,
iii. metadata representing the user parameters fixed before the capture of an image,
iv. metadata of the environment of the camera including, non-exhaustively, the characteristics of the illumination of the photographed scene.

The invention also relates to a camera as such, which has the particular feature of being both a color camera and a monochrome camera. By camera is meant any device equipped with an image sensor, able to take the form of a classic camera or the form of a mobile telephone, a tablet, etc.

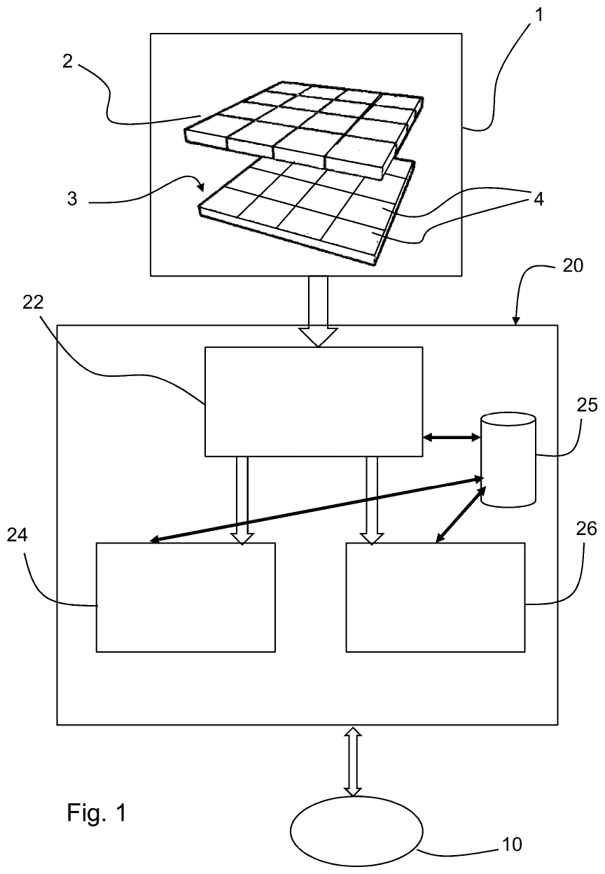

The camera, represented schematically in FIG. 1, therefore comprises an optical device 1 notably comprising a color filter 2 associated with an image sensor 3 in order to be able to generate a color photograph in the classic manner. It further comprises a human-machine interface 10 that enables a user to choose a color or monochrome operating mode. It further comprises a software module 20 configured to execute a method of generating a digital data file representative of the information received by the image sensor, either of color type or of monochrome type, depending on the color or monochrome operating mode chosen by the user. This software module comprises a classic image signal processor, often referred to as an interface signal processor (ISP), which is provided for the transformation of a raw (RAW) digital file into a viewable digital file, in the classic manner. This ISP is divided into two processors, a color first ISP 24 and a monochrome second ISP 26. This software module also comprises a pre-processing unit 22 that generates a monochrome type raw digital file on the basis of information coming directly from the photosites 4 of the image sensor 3 of the camera. This pre-processing unit 22 can therefore execute the method described above. Additionally, the camera comprises at least one electronic memory 25 intended to receive the generated raw digital files and the viewable digital files.

The invention is not limited to the embodiment described. In all cases it is advantageous to proceed to processing the data received by the image sensor upstream of the ISP 24, 26 of a camera to generate a monochrome digital file with a view to the future construction of a monochrome image. The fact of carrying out processing as close as possible to the image sensor makes it possible to guarantee the recovery of a maximum of information on the image as perceived by the image sensor 3 of the camera, with a view to being able to obtain a monochrome image of high quality after future processing of that information.

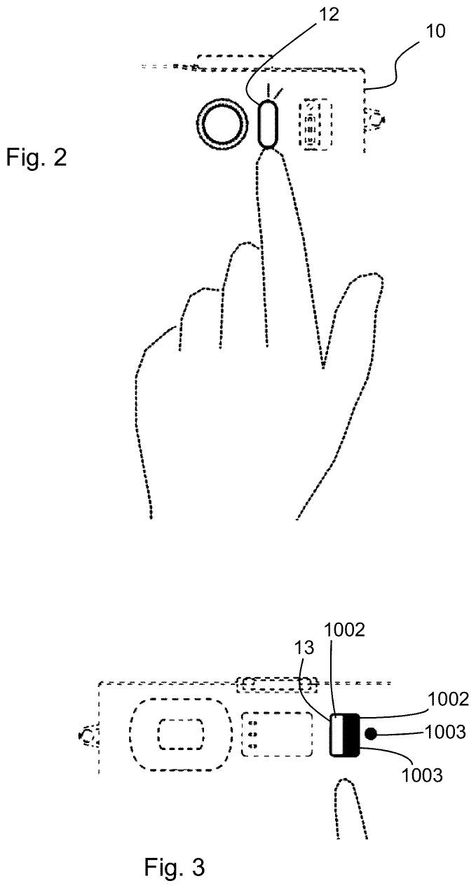

The human-machine interface 10 advantageously comprises an actuator, for example a two-position actuator, such as a pushbutton 12 or a slider 13, represented in FIGS. 2 and 3, respectively, these two positions respectively corresponding to the color and monochrome operating modes. This actuator may be mechanical or touch-sensitive on a screen. In the case of a button, double clicking may be used to prevent unintentional actuation.

Alternatively or additionally, the human-machine interface 10 may be on a remote object, separate from the camera, such as a remote control or a telephone, for example a mobile telephone application connected to the camera.

Furthermore, the human-machine interface 10 advantageously comprises an indicator of the operating mode selected. That indicator may also be present in the viewfinder of the camera so that the user knows what type of photograph they are in the process of taking.

The camera may comprise additional devices for adjusting the color to monochrome conversion to reproduce other creative aspects of black and white photography:
one or more user interfaces enabling configuration of the additional parameters of the conversion of the color camera converted to monochrome mode;
a device for management of the additional parameters to be applied to the device for adaptation of the response of the pixels of the image sensor;
one or more additional devices for adaptation of the response of the pixels of the image sensor, by way of non-exhaustive example:
a device for modification of the response curve of the pixels (tone curve) stored in the raw (RAW) file to be applied by external devices for production of an image ready to be viewed; said device enables reproduction of the creative possibilities of analog photography linked to the difference of rendition between different types of black and white films;
a device for modification of the response of the pixels according to the frequency of the light captured by the latter, stored in the raw (RAW) file; by way of non-exhaustive example such a device enables reproduction of the creative processes of using a monochrome camera the lens of which is equipped with a removable color filter (for example an orange filter) to highlight the vegetation or the sky in a photograph or to use the response of the image sensor beyond the range of visible colors (for example near infrared photography);
a device for modification of the response of the pixels according to the spatial organization of the image captured by the image sensor; by way of non-exhaustive example such a device enables modification of the resolution of the details of the captured image or transformation of the digital noise of the pixels into a different form of image grain comparable to the grain of a negative film.

1. A method for generating a digital data file representative of information received by an image sensor of an optical device of a color camera, wherein the method comprises:
registering a monochrome mode selected by a user via a human-machine interface;
receiving, by the image sensor comprising a multitude of photosites, luminous intensity through an optical device comprising a color filter intended to form a color image;
calculating an estimate of a monochrome luminous intensity that would be received by all or some of the photosites or groups of photosites of the image sensor, without the presence of the color filter of the optical device;
storing a digital file representative of the monochrome image perceived by the image sensor, comprising, for all or some of the photosites or groups of photosites of the image sensor, a digital datum representative of the received monochrome luminous intensity, without a color filter, resulting from the calculating of the estimate.

2. The method as claimed in claim 1, wherein the calculating of the estimate of the monochrome luminous intensity received by a given photosite takes into account a luminous intensity received by a plurality of adjacent photosites of the image sensor.

3. The method as claimed in claim 2, wherein the calculating of the estimate of the monochrome luminous intensity received by the given photosite:
considers the monochrome luminous intensity to be equal to a maximum luminous intensity received from the plurality of adjacent photosites, or
calculates the monochrome luminous intensity by means of a weighted sum as a function of a color of the luminous intensity received by the plurality of adjacent photosites.

4. The method as claimed in claim 1, wherein the calculating of the estimate comprises:
transferring to a preprocessing unit an electrical signal representative of a quantity of photons received by at least one photosite of the image sensor; and
following reception of electrical signals representative of the quantity of photons received by the at least one photosite and a few adjacent photosites of the image sensor, calculating gradually as the electrical signals are received an estimate of the monochrome luminous intensity received by the at least one photosite; and
storing in the digital file a digital datum representative of the monochrome luminous intensity received by the at least one photosite;
or
calculating an estimate of a monochrome luminous intensity received by some or all of the photosites or groups of photosites of the image sensor after receiving electrical signals representative of the quantity of photons received by each photosite of the image sensor.

5. The method as claimed in claim 1, wherein the digital file representative of the monochrome image perceived by the image sensor is a RAW type raw digital file.

6. The method as claimed in claim 5, wherein the raw digital file comprises for some or all of the photosites or groups of photosites of the image sensor the digital datum representative of the monochrome luminous intensity at least 12 bits in size.

7. The method as claimed in claim 1, wherein the digital file representative of the monochrome image perceived by the image sensor further comprises some or all of the following information:
a digital datum relating to the modification of a tone response curve of the pixels;
a digital datum relating to a modification of a response of the pixels according to a frequency of a light captured by thepixels;
a digital datum relating to a modification of a response of the pixels according to a spatial organization of an image captured by the image sensor.

8. A method of generating a monochrome photograph, comprising:
performing the method as claimed in claim 1, for generating a raw digital data file representative of the information received by an image sensor of a color camera, and
transmitting the digital data from the digital data file to a processing unit that transforms a raw digital data file into another format that is viewable.

9. A camera comprising:
an optical device comprising a color filter and an image sensor in order to generate a color photograph,
a human-machine interface enabling a user to choose a color or monochrome operating mode of the camera, and
a software module configured to execute a method for generating a digital data file representative of information received by the image sensor, either of color type or of monochrome type, depending on a color operating mode or monochrome operating mode chosen by a user.

10. The camera as claimed in claim 9, wherein the human-machine interface comprises a two-position actuator, the actuator having two positions respectively corresponding to the color and monochrome operating modes.

11. The camera as claimed in claim 10,
wherein the software module is configured to perform a method for generating a digital data file representative of information received by an image sensor of an optical device of a color camera, wherein the method comprises:
registering a monochrome mode selected by a user via a human-machine interface;
receiving, by the image sensor comprising a multitude of photosites, luminous intensity through an optical device comprising a color filter intended to form a color image;
calculating an estimate of a monochrome luminous intensity that would be received by all or some of the photosites or groups of photosites of the image sensor, without the presence of the color filter of the optical device;
storing a digital file representative of the monochrome image perceived by the image sensor, comprising, for all or some of the photosites or groups of photosites of the image sensor, a digital datum representative of the received monochrome luminous intensity, without a color filter, resulting from the calculating of the estimate, and
wherein the camera comprises a pre-processing unit adapted to convert electrical signals coming from the photosites of the image sensor into digital data representative of a monochrome luminous intensity to form a raw digital file and a separate image signal processor ISP for transforming the raw digital file into a viewable digital file.

12. The camera as claimed in claim 10, wherein the two-position actuator is a pushbutton or a slider.

13. The camera as claimed in claim 10, further comprises an indicator of the operating mode.

14. The method as claimed in claim 5, wherein the raw digital file comprises for some or all of the photosites or groups of photosites of the image sensor the digital datum representative of the monochrome luminous intensity at least 14 bits in size.

15. The method as claimed in claim 5, wherein the raw digital file comprises for some or all of the photosites or groups of photosites of the image sensor the digital datum representative of the monochrome luminous intensity at least 16 bits in size.

16. The method as claimed in claim 2, wherein the calculating of the estimate comprises:
transferring to a preprocessing unit an electrical signal representative of a quantity of photons received by at least one photosite of the image sensor; and
following reception of electrical signals representative of the quantity of photons received by the at least one photosite and a few adjacent photosites of the image sensor, calculating gradually as the electrical signals are received an estimate of the monochrome luminous intensity received by the at least one photosite; and
storing in the digital file a digital datum representative of the monochrome luminous intensity received by the at least one photosite;
or
calculating an estimate of a monochrome luminous intensity received by some or all of the photosites or groups of photosites of the image sensor after receiving electrical signals representative of the quantity of photons received by each photosite of the image sensor.

17. The method as claimed in claim 3, wherein the calculating of the estimate comprises:
transferring to a preprocessing unit an electrical signal representative of a quantity of photons received by at least one photosite of the image sensor; and
following reception of electrical signals representative of the quantity of photons received by the at least one photosite and a few adjacent photosites of the image sensor, calculating gradually as the electrical signals are received an estimate of the monochrome luminous intensity received by the at least one photosite; and
storing in the digital file a digital datum representative of the monochrome luminous intensity received by the at least one photosite;
or
calculating an estimate of a monochrome luminous intensity received by some or all of the photosites or groups of photosites of the image sensor after receiving electrical signals representative of the quantity of photons received by each photosite of the image sensor.

18. The method as claimed in claim 2, wherein the digital file representative of the monochrome image perceived by the image sensor is a RAW type raw digital file.

19. The method as claimed in claim 3, wherein the digital file representative of the monochrome image perceived by the image sensor is a RAW type raw digital file.

20. The method as claimed in claim 4, wherein the digital file representative of the monochrome image perceived by the image sensor is a RAW type raw digital file.
